(19) United States
(12) Patent Application Publication
(10) Pub. No.: US 2013/0246385 A1
(43) Pub. Date: Sep. 19, 2013

(54) EXPERIENCE RECOMMENDATION SYSTEM BASED ON EXPLICIT USER PREFERENCE

(71) Applicants: David Barlin, Newcastle, WA (US); Simon P. King, Berkeley, CA (US); Rahul Nair, Daly City, CA (US); Marc Eliot Davis, San Francisco, CA (US); Imran Aziz, Seattle, WA (US)

(72) Inventors: David Barlin, Newcastle, WA (US); Simon P. King, Berkeley, CA (US); Rahul Nair, Daly City, CA (US); Marc Eliot Davis, San Francisco, CA (US); Imran Aziz, Seattle, WA (US)

(73) Assignee: MICROSOFT CORPORATION, Redmond, WA (US)

(21) Appl. No.: 13/531,975

(22) Filed: Jun. 25, 2012

Related U.S. Application Data
(63) Continuation-in-part of application No. 13/419,371, filed on Mar. 13, 2012.

(51) Int. Cl. G06F 17/30

(52) U.S. Cl. 707/706; 707/E17.108

(57) ABSTRACT

Presented in this disclosure are systems and methods for enabling access to content from a preferred source to a computer user is presented. A preferred source is a source of content that a user has identified as being “preferred.” Once a user establishes a source as a preferred source (through a first channel), other channels by which the user can obtain content from the preferred source are identified. In various embodiments, the other channels are automatically enabled for the user or, alternative, presented to the user for opting into receiving the content from that channel.

### BACKGROUND

Just as individual tastes vary in regards to food, activities, brands, clothing, and the like, different individual tastes also vary with regard to online sources of information. Accordingly, some leading search engines have begun customizing the search results they generate in response to a query received from a particular user according to the user's specific preferences. However, while some of these preferences can be detected implicitly via click through data browsing habits, prior search queries, and even a user's social network, there are advantages to allowing a user to state his/her preferences explicitly.

Often, a user will have a specific preference with regard to the source of content that he/she would like to see. In other words, a user may have a specific preference for content that originates from, or is sponsored by, a “preferred source.” For example, a user may have a preference of viewing search results for news from a specific source such as MSNBC or CNET. Thus, when search results are obtained in response to a search query, ideally those search results that reference content from a preferred source would be promoted to, or placed in, more prominent positions in the search results. Once a preferred source is established, this preference can be leveraged to any number of other touch points/channels the user has with an online environment.

### SUMMARY

The following paragraphs present a simplified summary in order to provide a basic understanding of various embodiments of the subject matter described herein. This summary is not an extensive overview and it is not intended to identify key and/or critical elements or to delineate the scope of the disclosed subject matter. The sole purpose of this summary is to present some concepts in a simplified form as a prelude to the more detailed description that follows.

According to aspects of the disclosed subject matter, systems and methods for enabling access to content from a preferred source to a computer user is presented. Once a user establishes a source as a preferred source (through a first channel), other channels by which the user can obtain content from the preferred source are identified. In various embodiments, the other channels are automatically enabled for the user or, alternative, presented to the user for opting into receiving the content from that channel.

While various novel aspects of the disclosure subject matter have been set forth in this summary, it should be appreciated that they are for illustration purposes and should not be construed as a complete summary of the novel aspects of the disclosed subject matter that are set forth this document.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a diagram of an illustrative environment in which user personalization according to preferred sources can be implemented;

FIG. 2 illustrates an exemplary browser window showing search results responsive to a search query but have not been personalized according to explicit user personalization;

FIG. 3 illustrates an exemplary browser window showing search results responsive to a search query that are updated according to explicit user personalization;

FIG. 4A illustrates an exemplary user interaction with regard to a search result identified as being from a preferred source;

FIG. 4B illustrates an exemplary user interaction with regard to a search result that is not from a preferred source;

FIG. 5 illustrates an exemplary browser window 500 for displaying and editing a user's preferred sources;

FIG. 6 illustrates a flow diagram, as executed by a search engine, for receiving an indication from a user that the source of a search result is to be preferred for that user;

FIG. 7 illustrates a flow diagram, as executed by a search engine, for receiving explicitly identified preferred sources;

FIG. 8 illustrates a flow diagram for presenting and processing recommended preferred sources to a user;

FIG. 9 illustrates a flow diagram for processing a set of search results responsive to a user's query in accordance with the user's preferred sources;

FIG. 10 illustrates various components of a computing system suitable for personalizing search results according to a user's preferred sources;

FIG. 11 illustrates an alternative flow diagram for processing a set of search results responsive to a user's query in accordance with the user's preferred sources;

FIG. 12 is a flow diagram of an illustrative routine suitable for recommending or establishing channels of a preferred source for a user; and

FIG. 13 illustrates a pictorial diagram illustrate a view for presenting recommended channels for the user.

### DETAILED DESCRIPTION

For purposed of clarity, the use of the term “exemplary” in this document should be interpreted as serving as an illustration or example of something, and it should not be interpreted as an ideal and/or leading illustration of that thing.

As used throughout this document, a “source” is an entity that creates, generates, and/or promotes content that can be acted on (often viewed) by a user. Examples of sources include, but are not limited to, a news organization (such as MSNBC or the Huffington Post), an author, a blogger, an organization or association, and the like. A source is distinct from content in that content is originated and/or promoted by the source. In other words, content “flows” from its source. In the context of a search engine responding to a search query, the links/references returned as search results to the search query are links to content, whereas the originator of the referenced content is the source of the content. In this regard, a link to an article published by MSNBC on “Syrian protests” is a link to content (the article on Syrian protests) from a source (MSNBC). Content originated by a source may be published through various conduits and channels. For example, a popular, well-published author such as Dave Barry (a source) may publish content through different channels such as a Dave Barry web site, a news service (e.g., the Miami Herald), books, and the like. A “preferred source,” then, is a source that is preferred by a user and an “explicitly preferred source” is a source that has been explicitly identified by a user as a preferred source for that user. For purposes of this document, when referring to a “preferred source” without other modifiers, it is to be assumed that it is a reference to an explicitly preferred source.

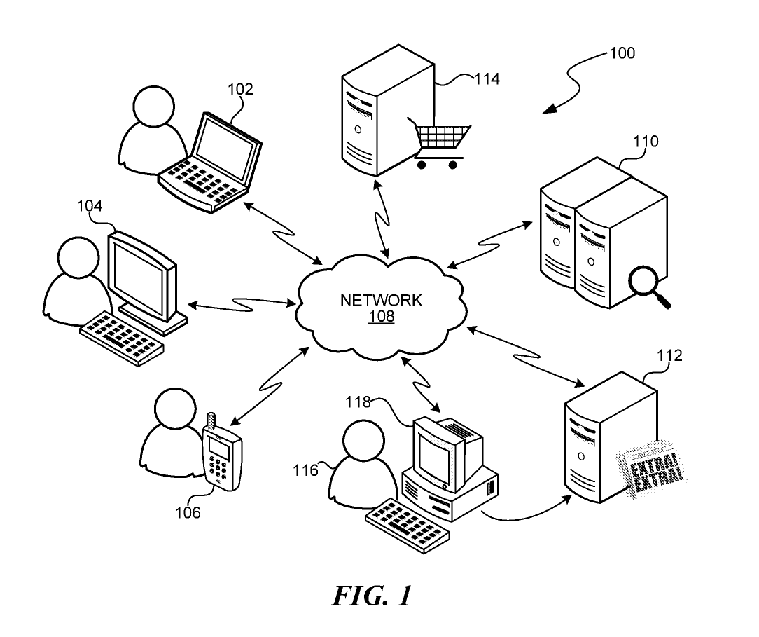

Turning now to the figures, FIG. 1 shows a diagram of an illustrative environment 100 in which user personalization according to preferred sources can be implemented. The illustrative environment 100 includes one or more user computers, such as user computers 102-106, connected to a network 108, such as the Internet, a wide area network or WAN, and the like. Also connected to the network 108 is a search engine 110 that responds to search queries received from various users, such as the users connected to user computers 102-106. Further connected to the network 108 are one or more sources of various types, such as news organization 112, shopping site 114, and an author 116 directly connected to the network via the author's own computer system 118 as well as indirectly connected to the network via news organization 112.

As those skilled in the art will appreciate, suitable user computers for operating in the illustrative environment 100 include any number of computing devices that can communicate with the search engine 110 over the network 108 in both submitting user queries and receiving a response of search results page from the search engine 110. The user computers 102-106 are also configured to enable a corresponding user to identify a source as a preferred source. User computers 102-106 may communicate with the network 108 via wired or wireless communication connections. These user computers 102-106 may include, but are not limited to, laptop computers such as user computer 102, desktop computers such as user computer 104, mobile phone devices such as user computer 106, tablet computers (not shown), on-board computing systems (not shown) such as those found in vehicles, mini- and/or main-frame computers (not shown), and the like.

Those skilled in the art will appreciate that a search engine 110 corresponds to an online service hosted on one or more computers on or computing systems distributed throughout the network 108. The illustrated search engine 110 is shown as comprising two computing devices but this is illustrative only. The online search service hosted by search engine 110 receives search queries over the network 108 and, in response to the queries, identifies a set of search results (typically references to content) that the search engines identifies as being relevant to a received search query. In addition to identifying the search results that are relevant to the search query, according to novel aspects of the disclosed subject matter the search engine 110 personalizes the search results according to the preferred sources of the user submitting the search query. This personalization is accomplished at least by determining whether any of the search results responsive to a search query correspond to a preferred source of the user that submitted the search query. For those results that are identified as corresponding to a preferred source, those identified search results are repositioned in the search results page to more prominent positions in the search results list. The search engine further generates a search results page for presentation to the user based on the rearranged search results list, and returns the search results page to the requesting user.

Those skilled in the art will appreciate that the search results that the search engine obtains in response to a search query are ordered in the sense that those search results deemed more relevant and/or likely to be desired by the user are located in the first portion of the search results list. Often, the search results in the search results list will be associated with a relevance score. Rearranging search results to a more prominent position means taking search results from their current position within the search results list and placing them closer to the start of the list. An earlier position in the search results list is “more prominent” as the earlier results in the search results list are those that are most likely viewed by a user. According to various embodiments, rearranging/repositioning the search results to more prominent positions can be accomplished irrespective of the scores associated with the search results or, alternatively, the scores of the search results that are from preferred sources can be rescored with additional weighting in light of their origin from a preferred source. In addition to earlier in the search results list, prominence may also be made with regard to the search results page in which the results will be included, as well as the position of the “preferred results” on a search results page with respect to the other results on the same search page.

Returning to FIG. 1, the illustrative environment 100 includes a shopping site 114 connected to the network 108. In this environment 100, the shopping site 114 provides information (i.e., content) to, or is crawled by, the search engine 110 regarding products that are available for purchase on the shopping site. This information is then used by the search engine 110 when responding to relevant search queries for those products or services. Hence, assuming that shopping site 114 is a preferred source for a particular user, when responding to search queries from that user content from the shopping site will be promoted to more prominent positions in the search results pages that are returned from the search engine 110.

The illustrative environment 100 also includes a news organization 112. As mentioned above, the news organization 112 may be viewed as a preferred source such that the news articles that are published by the news organization are content. Just as with the shopping site 114, the search engine 110 will be informed of, or will crawl, the articles. Accordingly, when responding to search queries, content from preferred sources (such as news organization 112—assuming it is a preferred source) will be promoted to more prominent positions in the search results that are returned from the search engine 110 to the user in response to the search query.

The illustrative environment 100 further includes an author 116 (i.e., a source of content) connected to the network 108 via the author's own computer system 118 as well as via the news organization 112. This is illustrative of the fact that content from the author 116 may be distributed through any number of channels, i.e., the author's own system 118 as well as the news organization 112. This further shows that the news organization 112 can server both as a conduit for content (i.e., articles by the author 116) and as well as a source itself. The content from the author will then be indexed by the search engine 110, as is known to those skilled in the art, such that the content can be served to users in response to relevant search queries.

While FIG. 1 is described in regard to a variety of devices, components and sources, those skilled in the art will appreciate that in an actual embodiment, there are likely numerous shopping sites, news organizations, authors, and other “sources” connected to the network 108 and the search engine 110. The search engine 110 is informed of, or crawls, numerous sites in an effort to identify and index the available content and their source such that the content can be served to users in response to search queries.

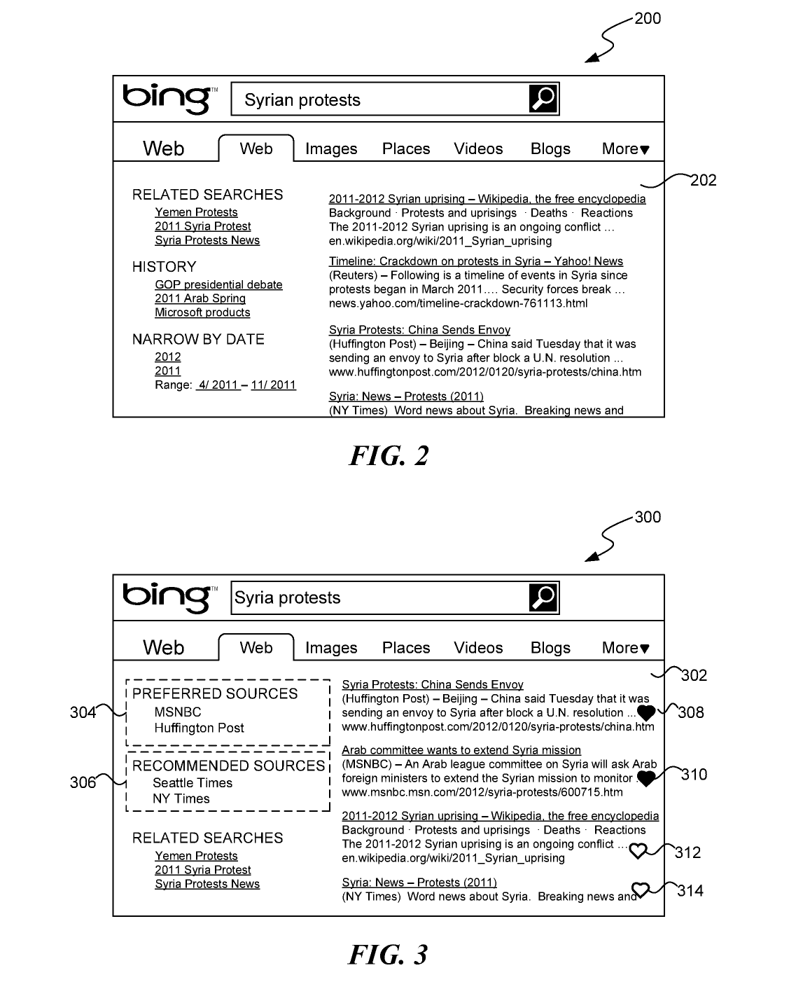

Turning now to FIG. 2, this figure illustrates an exemplary browser window 200, as executed on a user computer, such as any one of user computers 102-106 of FIG. 1. The browser window 200 shows typical search results 202 responsive to a search query, in this case “Syrian protests.” While typical search results may be customized according to a user's preferences in which some items are explicitly identified (friends, specific articles, activities, etc.) and others are implied by the system, current search engines fail to enable a user to explicitly prefer a source of content and subsequently arrange search results from a query with regard to the preferred sources. Accordingly, these search results 202 have not been updated according to explicit user personalization with regard to preferred sources.

By way of example to illustrate personalization based on preferred sources, assume that MSNBC and Huffington Post are the user's preferred sources. For the search, Syrian protests, since the search engine 110 has not personalized the search results 202 according to the user's preference of these two preferred sources, the search results from these sources are not necessarily given the appropriate level of prominence. Indeed, the search results 202 do not include any references from MSNBC—a preferred source.

In contrast to FIG. 2, FIG. 3 illustrates an exemplary browser window 300 as may be executed on the same user computer as in FIG. 2, but showing search results responsive to the same search query as above that are further updated according to the user's explicit preferred sources (as discussed in the example of the prior paragraph.) As can be seen, the content corresponding to the user's preferred sources (Huffington Post and MSNBC) are placed in prominent positions in the search results 302. Moreover, in this illustrative browser window 300, icons 308 and 310 are used to indicate the search results that reference content from the user's preferred sources.

It should be appreciated that in identifying and repositioning search results (i.e., content) from preferred sources, the search engine 110 is working with search results that have already been identified as being relevant to some degree or another. Of course, while the illustrative browser window 300 has the search results from the preferred sources in the most prominent positions (i.e., the first and second results), the search engine 110 may not be constrained to place content from preferred sources in specific positions. As those skilled in the art will appreciate, individual search results in the set of search results responsive to a query are scored with regard to the query. Typically, those search results with the highest score are placed in positions of greater prominence. Customizing the search results according to user personalization means that certain search results are weighted differently. According to one embodiment of the disclosed subject matter, the search engine 110 adds explicitly preferred sources as a weighting criterion or value to the scores. A search engine service would be free to choose the amount of weighting to lend to explicitly preferred sources.

With regard to customizing the search results according to the user and also in identifying search results that are from preferred sources, while some search engines allow a user to rearrange the order of the search results, the rearranging is limited to the current page of search results (i.e., the 10 search results displayed per each page—also referred to as the “10 blue links”.) However, knowing that a user prefers a particular source for content, search results that might otherwise fall outside of the first page of results may actually be highly relevant. Thus, in accordance with the disclosure subject matter, the search engine 110 searches through the first n search results for content from a preferred source, where n is a number greater than the results on a page of search results. By way of example and not to be meant as limiting, n may be the first 50 results or the first 100 results.

In regard to FIG. 3, in addition to the icons that indicate search results to content from preferred sources (such as icons 308 and 310), the illustrative browser window 300 includes additional user interface tools. Since only a few search results of a search page can be displayed “above the fold” (meaning those search results in a search results page that are visible when initially displayed in a window, such as browser window 300), a list 304 is shown that indicates the presence of content from preferred sources in the search results page. For example, list 304 of the browser window 300 identifies the user's preferred sources that are found in the entire search results page. Similarly, list 306 provides suggestions to the user with regard to other sources that the user may wish to add as a preferred source. Recommended sources are not necessarily constrained to those sources of search results that are included on the search results page.

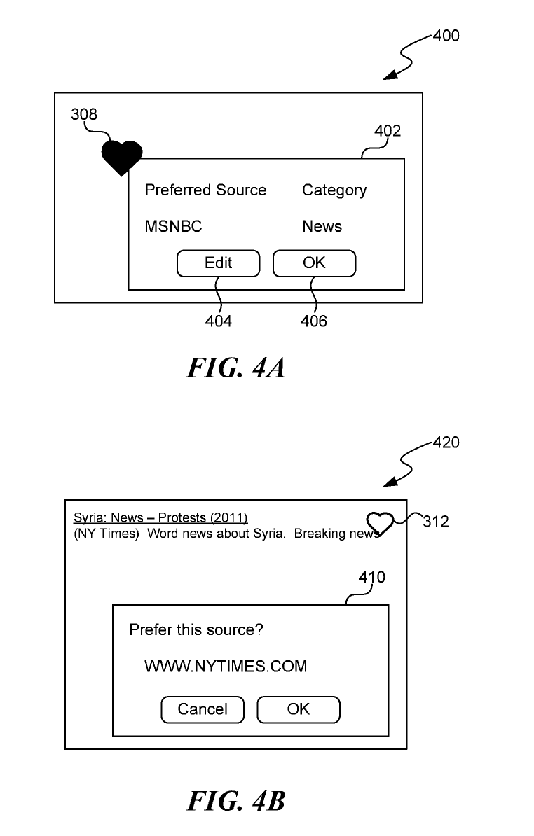

In addition to the preferred sources list 304 and recommended sources list 306, the generated search results page may also include icons 312 and 314 are actionable icons in conjunction with search results that do not correspond to preferred sources. In other words, actionable icons provide an easy manner in which a user may include the source of the search result as a preferred source. In fact, both icons 308-310 and icons 312-314 may be actionable icons thereby giving the user the ability to control the user's own preferred sources. For example, FIG. 4A illustrates an exemplary view 400 with regard to a search result identified as being from a preferred source. Thus, by way of example, upon selecting icon 308, an interactive window 402 may be displayed showing both the preferred source, in this example MSNBC, a category in which this source is to be preferred (“News”), and interactive controls 404 and 406 by which a user may edit/change information regarding the particular preferred source. Similarly, FIG. 4B illustrates an exemplary view 420 with regard to a search result that is not from a preferred source. In this example, upon selecting icon 312, an interactive window 410 is presented with controls that enable the user to add the source of the particular search result as one of the user's preferred sources.

As mentioned above in regard to FIG. 4A, it is further anticipated that a suitably configured search engine 110 will enable a user to not only explicitly identify and manage preferred sources of content, but also identify a category (or domain) in which a preferred source is preferred. For example, in FIG. 4A the interactive window 402 shows that the preferred source, MSNBC, is preferred when the category of content is “News.” Hence, assuming that a user prefers MSNBC just for news (as shown in interactive window 402) if the user submits a search query regarding dining, MSNBC would not be a preferred source and content from MSNBC would not be promoted as described above. According to various embodiments of the disclosed subject matter, a search engine 110 could enable a user to prefer a source and optionally associate one or more categories with that source. It is further anticipated that a user may associate subcategories of varying levels, with a preferred source. Moreover, a preferred source may be associated with more than one category/subcategory.

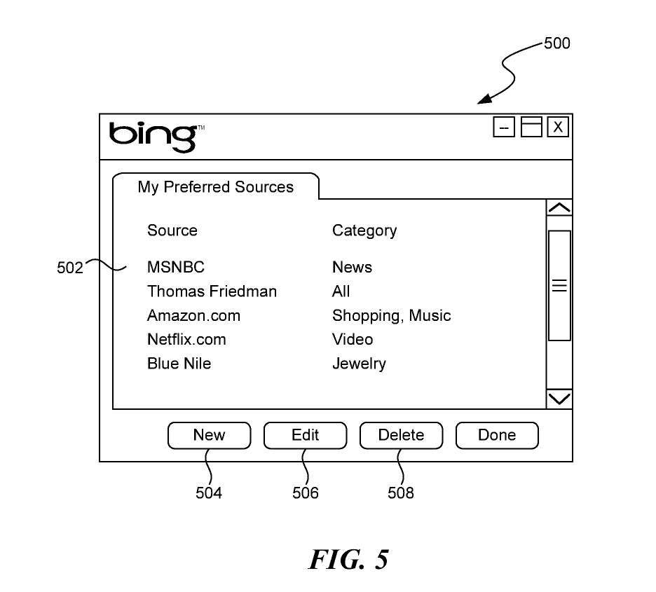

Part of enabling users to explicitly prefer sources is that a user should be able to control his/her own preferences. To that end, FIG. 5 illustrates an exemplary browser window 500 for displaying and editing a user's preferred sources. As can be seen in the browser window 500, a list of preferred sources 502 associated with the user is presented along with a corresponding category for the preferred sources. Controls 506-508 are provided to enable the user to edit or delete aspects of preferred sources, as well as a control 504 to add a new preferred source.

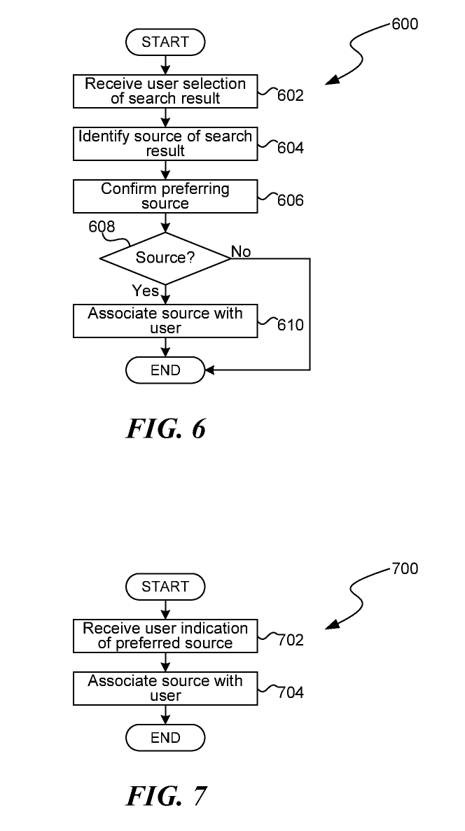

Turning now to FIG. 6, this figure illustrates a flow diagram of a computer-implemented routine 600, as executed by a search engine 110, for adding the source of a search result to the user's list of preferred sources. Beginning at block 602, the search engine 110 receives a user's selection of a search result. While it is anticipated that there are numerous manners in which a user may identify a content source for inclusion in the user's list of preferred sources, the examples of FIG. 3 and FIG. 4B discussed above illustrate one such manner, i.e., selecting icon 312 a user may prefer the source of the search result. Accordingly, at block 604, the search engine 110 identifies the source of the selected search result. At block 606, the search engine 110 presents a message to the user confirming the user's selection of the source of the search result as a preferred source. At decision block 608, the search engine 110 confirms whether or not the user intends to prefer the identified source. If the user does not confirm the use of the source of the search result as a preferred source, the routine 600 terminates. However, if the user confirms the use of the source as a preferred source, at block 610, the search engine 110 associates the identified source with the user as a preferred source. Thereafter, the routine 600 terminates.

As mentioned earlier, a user is not constrained to identifying preferred sources through icons associated with search results. To that end, FIG. 7 illustrates a flow diagram of a computer-implemented routine 700, as executed by a search engine 110, for receiving explicitly identified preferred sources. Beginning at block 702, the search engine receives a user indication of a preferred source. At block 704, the search engine associates the preferred source with the user. Thereafter, the routine 700 terminates.

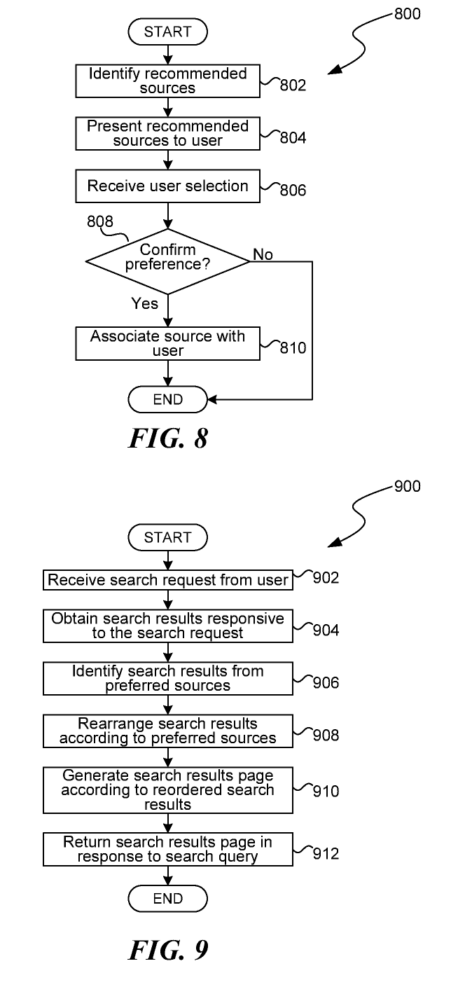

FIG. 8 illustrates a flow diagram of a computer-implemented routine 800, as implemented by a search engine 110, for presenting and processing recommended sources to a user as potential preferred sources. Beginning at block 802, the search engine identifies a number of recommended sources that the user may wish to adopt as preferred sources. At block 804, the identified recommended sources are presented to the user. At block 806, the search engine receives a user selection regarding a recommended preferred source. At decision block 808, the search engine 110 confirms with the user that the user wishes to use the selected source as a preferred source. If the user declines to confirm, the routine 800 terminates. Alternatively, if the user confirms the use of the recommended source as a preferred source, at block 810, the search engine 110 associates the source as a preferred source with the user. Thereafter, routine 800 terminates.

FIG. 9 illustrates a flow diagram of a computer-implemented routine 900 for processing a set of search results responsive to a user's query in accordance with the user's preferred sources. Beginning at block 902, the search engine 110 receives a search request from the user via a user computer, such as user computer 102. At block 904, the search engine obtains a set of search results responsive to the user's search request. At block 906, the search engine 110 identifies those search results where the source of the search result corresponds to a preferred source for the user. At block 908, the search engine rearranges (i.e., customizes and/or personalizes) the set of search results for the user such that the search results from preferred sources are placed in more prominent positions within the set of search results. At block 910, a search results page is generated according to the rearranged set of search results. At block 912, the generated the search results page is returned in response to the search query. Those skilled in the art will appreciate that in generating a search results page, a search engine 110 will often include one or more advertisements in the search results page. According to various embodiments, advertisements may be selected for inclusion in the search results page. By way of a non-limiting example, an advertisement may be selected when the advertisement corresponds to the preferred source of a search result in the search results page. Thereafter, the routine 900 terminates.

Regarding FIGS. 6-9, it should be appreciated that while routines 600-900 are expressed with discrete steps, these steps should be viewed as being logical in nature and may or may not correspond to any actual, discrete steps. Those skilled in the art will appreciate that logical steps may be combined together or be comprised of multiple steps. Further, while novel aspects of the disclosed subject matter are expressed in routines or methods, this functionality may also be embodied in computer-readable media. As those skilled in the art will appreciate, computer-readable media can host computer-executable instructions for later retrieval and execution. When executed on a computing device, the computer-executable instructions carry out various steps or methods. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

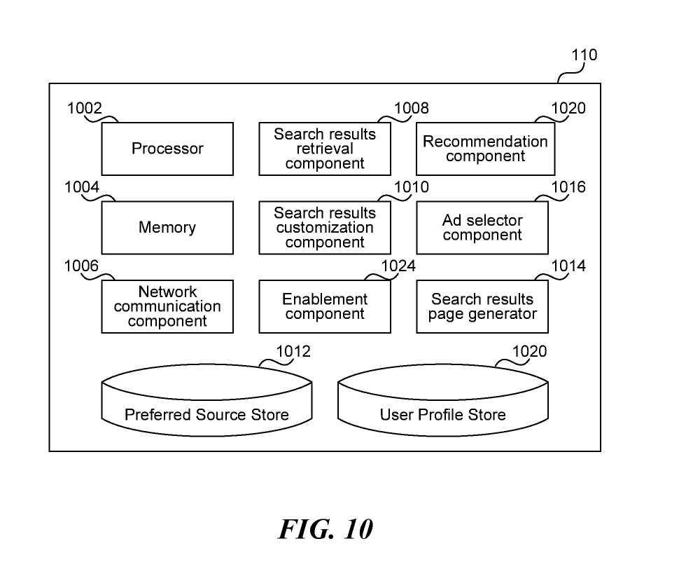

Turning now to FIG. 10, this figure shows a block diagram illustrating various components of a search engine 110 suitable to personalize search results according to a user's preferred sources. The search engine 110 includes a processor 1002 and a memory 1004. As those skilled in the art will appreciate, the processor 1002 executes instructions retrieved from memory 1004 in carrying out various aspects of the hosted service, including personalizing search results according to a user's preferred sources.

The search engine 110 also includes a network communications component 1006 through which the search engine sends and receives communications over the network 108. For example, it is through the network communication component 1006 that the search engine 110 receives search queries from user computers, such as user computers 102-106, and returns results responsive to the search queries. The search engine 110 further includes a search results retrieval component 1008, a search results personalization component 1010, a preferred source store 1012, a search results generator component 1014 and an ad selector component 1016.

The search results retrieval component 1008 retrieve/obtains a set of search results responsive to a user's search query. The search results personalization component 1010 rearranges the search results that were obtained from the search results retrieval component 1008 according to the user's preferred sources. Search results referencing content from preferred sources are place in more prominent positions in the rearranged set of search results. Frequently, these prominent positions include being placed on the first page of generated search results pages for the set of search results. Other prominent positions include earlier placement on a given search results page (such as one of the first three search results or above the fold). Of course, other personalization operations may take place within the search results personalization component 1010. These other customizations may include arranging the search results according to preferences implicitly derived by examining the user's browsing history, purchase history, and the like.

The preferred source store 1012 stores a list of preferred sources for each of a plurality of users. Typically, when a search engine 110 receives a search query from a user, the search engine will use that user's list of preferred sources as stored in the preferred source store 1012 when personalizing the search results for the user. However, in an alternative embodiment of the disclosed subject matter, the search engine 110 could enable a first user to use the preferred sources of a second user in personalizing the search results responsive to a search query from the first user. In another embodiment, the search engine 110 could enable a first user to use any number of combinations of preferred sources lists.

The search results page generator component 1014 is configured to generate one or more search results pages based on a set of search results. The search results page generator component 1014 is also configured to place a preferred source indicator proximate to those search results in a generated search results page that are from preferred sources. For those search results that are not from, or correspond to, preferred sources (i.e., the search results do not reference content from preferred sources), the search results page generator component 1014 is configured to place an actionable icon adjacent to a search result such that the user can readily preferred the source of the search result, i.e., add the source of a particular search result to the user's preferred source list in the preferred source store 1012.

The search results page generator component 1014 works with the ad selector component 1016 when generating a search results page. More specifically, the search results page generator component 1014 obtains suitable advertisements to be included in any given search results page. Moreover, according to novel aspects of the disclosed subject matter, the ad selector component 1016 selects suitable advertisements for inclusion in a search results page such that an advertisement corresponding to a preferred source is included in a search results page when a search result corresponding to that preferred source is included in the same search results page.

While the previous embodiments for personalizing search results according to a user's preferred sources have been largely described in terms of personalizing the results after a set of search results has been obtained, the disclosed subject matter is not so limited. In at least one alternative embodiment to those already described, information regarding a user's preferred sources is used as a signal to the service/component that retrieves or obtains a set of search results (such as the search results retrieval component 1008), such that results referencing content from preferred sources are already place in prominent positions among the set of search results. In such an embodiment, and if identifying the results referencing content from preferred sources is important, then the retrieved set of search results will include indications as to those that are from preferred sources. In short, search results referencing content from preferred sources can be placed in prominent positions after a set of search results has been retrieved, or the user's preferred sources can be supplied as a signal to the retrieval component such that search results referencing content from preferred sources are already placed in prominent positions when the search results set is retrieved.

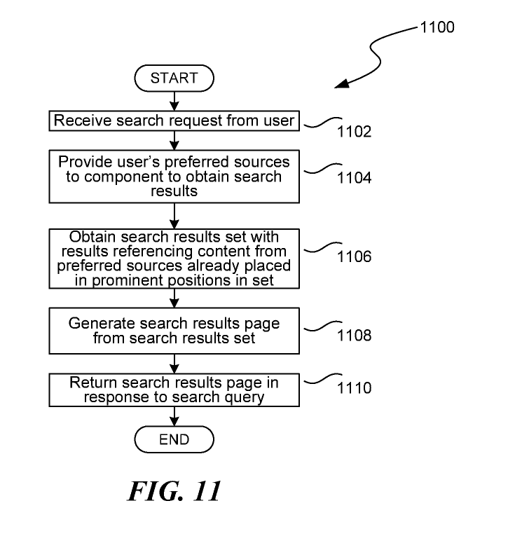

FIG. 11 shows a flow diagram of an exemplary routine 1100 illustrating these alternative embodiments of responding to a search query with a set of search results having those results referencing content from preferred sources located in more prominent positions in the set of search results. Beginning at block 1102, the search engine 110 receives a search request from the user via a user computer, such as user computer 102. At block 1104, the user's preferred sources are provided as a signal (i.e., information) to the service/component that retrieves a corresponding set of search results. At block 1106, the search engine 110 obtains a set of search results responsive to the user's search request. This set of search results is already arranged such that the results that reference content from a preferred source have been placed in positions of prominence in the set of search results. At block 1108, a search results page is generated according to the obtained set of search results. At block 1110, the generated the search results page is returned in response to the search query. Of course, just as with routine 900 discussed above, those skilled in the art will appreciate that in generating a search results page, a search engine 110 will often also include one or more advertisements in the search results page. Thereafter, the routine 1100 terminates.

In addition to providing more relevant results to a user in the context of interacting with a search engine, the fact that a user has preferred a source of content can be leveraged to any number of other channels the user has with an online environment. Indeed, a suitably configured search engine 110 can utilize a user's explicitly preferred source to recommend channels outside of the search engine through which the user can receive/access content from the preferred source. For example, assume that a user has, through interaction with a search engine 110, identified a web site associated with Porsche as a preferred source of content. As discussed above, this preference will result in search results referencing content from the Porsche web site to be placed in positions of greater prominence among search results received from the search engine 110. However, this source preference can be used to affect other touch points, i.e., the interaction between the user and the online world, by automatically establishing or recommending channels through which the user can obtain content from the preferred source. Thus, continuing the example above, once the user establishes the Porsche-related web site as a preferred source, this preference can be leveraged such that contact information for a local Porsche dealer is added to the user's contact list; the URL for Porsche is added to the user's favorites list in the user's browser; the user is subscribed to the Porsche owners newsfeed; Porsche apps and/or user manuals are installed on the user's mobile device or other computers; and the like. Of course, these are illustrative examples of channels through which a user may obtain content from a preferred source, and should not be viewed as limiting on the types of channels that may be recommended and/or established.

In addition to simply recommending or establishing channels through which a user can obtain content from a preferred source, the search engine 110 (or other service) can further take into account user contextual information, user demographics, and/or preferences and demographics of a user's social network in refining or selecting the channels. Examples of user contextual information include, but are not limited to, a user's current geographic location; the type of computer that is used; software employed on a user's device/computer; events in which the user participates; and the like. User preferences, other than preferred sources, include but are not limited to any number of items, brands, services, genres, organizations, and the like that a user has identified, either explicitly or implicitly, as being a preference (or a negative preference: i.e., “I don't like country music”) for the user. User preference information is usually stored in a profile associated with the user in a user profile data store. Each of these may play a role in identifying the user's touch points with the internet (and, thus, potential “locations” in which content from a preferred source may be presented to the user via a channel) as well as which channels are most appropriate.

Continuing the previous example, it may be important to know whether the user owns a Porsche vehicle or wishes to purchase a vehicle since the preferred source (Porsche) may provide different content for one or the other. Further, if the user owns a Porsche vehicle, it may be important to be able to differentiate between the types of Porsche vehicles available, whether the owner races his/her vehicle, is a weekend recreational driver, or uses the car to commute to work. In short, a content source may generate different content for a diverse set of contexts and, in recommending or establishing channels for a user, a search engine 110 would enhance the user experience by tailoring the channels as closely to user interests, contexts and profile data as possible.

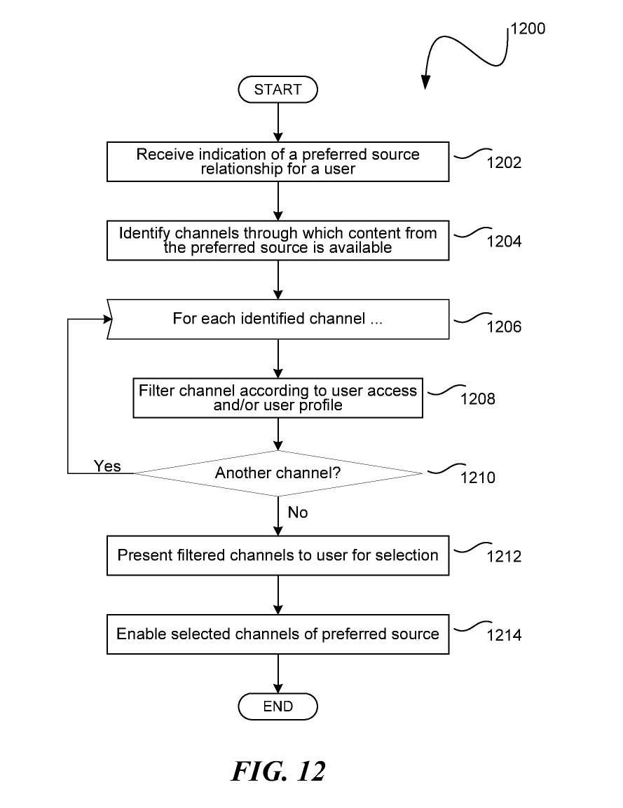

FIG. 12 is a flow diagram of an illustrative routine 1200 suitable for recommending or establishing channels of a preferred source for a user. As already mentioned, this routine 1200 may be carried out on a suitably configured search engine 110 (such as through a recommendation component 1022 of FIG. 10). Beginning at block 1202, an indication is received that a preferred source has been established by a user. At block 1204, a plurality of channels through which content from the preferred source are identified. When implemented on a search engine 110, information as to the various channels of content from the preferred source may be stored in the preferred source store 1012, the information being gathered by the various processes that crawls the network 108 for content as is known in the art.

At control block 1206, a looping construct is begun that iterates through each of the identified channels of block 1204. Thus, at block 1208, a channel (of the preferred source) is filed according to whether the user has access to the particular channel, and/or whether this particular channel is relevant to the user according to user profile information stored in the user profile store 1020 that stores contextual information related to a plurality of computer users. The result of the routine at block 1208 is that channels for the preferred source that are not accessible to the user or fall outside of a particular context related to the user are filtered out.

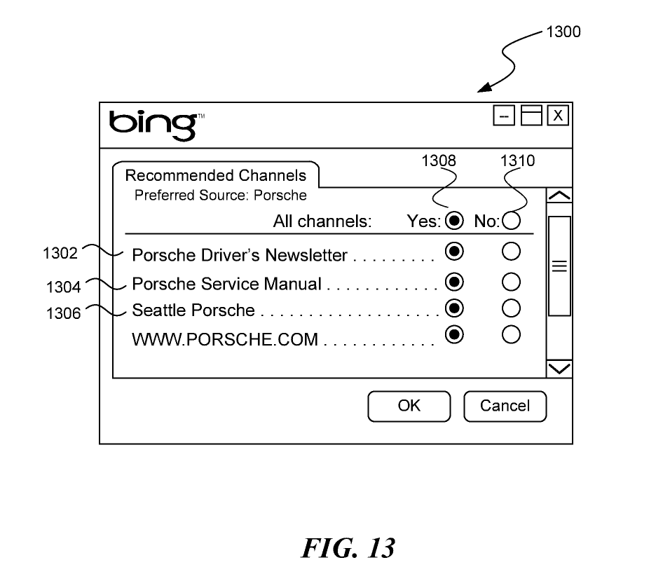

At decision block 1210, a determination is made as to whether there are any additional channels to consider. If so, flow of the routine 1200 returns to block 1206 where the next channel is considered. Otherwise, flow of the routine 1200 proceeds to block 1212 where (optionally) the remaining channels are presented to the user for user selection, i.e., to opt in. An example of a view for presenting recommended channels for the user is shown as view 1300 of FIG. 13. View 1300 presents exemplary recommended channels 1302-1306 for Porsche content that the user can opt in (or, if already enrolled can opt out.) Similarly, the user is provided with an option to opt-in 1308 or opt-out 1310 for all listed channels. In an alternative embodiment (not shown), the search engine 110 may automatically enable/enroll/initiate the remaining, filtered channels and provide the user with the ability to opt-out of any or all of them.

After identifying those channels that the user selected to be enabled (or if the filtered channels are to be automatically enabled), at block 1214 the selected channels are enabled. The particular mode in which a channel is enabled for a user is highly dependent on the channel. For example, enabling (subscribing) to a blog or newsletter from the preferred source may entail adding the user's email alias on a subscription list. Adding contact information for a preferred source to a user's contact list will require the use of other processes. The enablement of a particular channel is carried out by an enablement component 1024 (FIG. 10) in conjunction with information stored in the preferred source store 1012. This information may be manually generated, automatically generated according to analysis of information gathered on the web, or a combination of the two. Thereafter, the routine 1200 terminates.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for enabling access to content from a preferred source to a computer user, the method comprising:
establishing a source of content as a preferred source for a computer user through a first channel;
identifying a plurality of channels other than the first channel through which content from the preferred source is available;
selecting from the identified plurality of channels those channels with which the user interacts; and
enabling the flow of content from the preferred source to the user through the selected channels.

2. The method of claim 1, wherein the first channel is a search engine.

3. The method of claim 1, wherein the flow of content from the preferred source to the user through the selected channels is automatically enabled, and wherein the user is provided with the ability to opt out of receiving content from the preferred source from any of the selected channels.

4. The method of claim 1 further comprising presenting the selected channels to the user as recommended channels for the user with an option to opt in to receiving content from the preferred source from any of the selected channels; and
enabling the flow of content from the preferred source to the user through those channels for which the user opts in.

5. The method of claim 1, wherein selecting from the identified plurality of channels those channels with which the user interacts further comprises selecting from the identified plurality of channels those channels with which the user interacts and according to profile information related to the user.

6. The method of claim 1, wherein enabling the flow of content from the preferred source to the user through the selected channels comprises initiating the installation of a computer-executable module on a computing device associated with the user.

7. The method of claim 1, wherein enabling the flow of content from the preferred source to the user through the selected channels comprises subscribing to a content feed associated with the preferred source.

8. The method of claim 1, wherein enabling the flow of content from the preferred source to the user through the selected channels comprises adding contact information for the preferred source in a communication module on a computing device associated with the user.

9. A computer system for enabling access to content from a preferred source to a computer user, the system comprising a processor and a memory, wherein the processor executes instructions stored in the memory as part of or in conjunction with additional components enabling access to content from the preferred source to the computer user, the additional components including:
a preferred source store, the preferred source store storing data regarding a plurality of content sources, including one or more channels corresponding to each content source by which content from the corresponding content source can be accessed;
a user profile store storing user profile information corresponding to a plurality of computer users;
a recommendation component, that in response to a user establishing a content source as a preferred source identifies one or more channels related to the preferred source; and
an enablement component that enables the user to access content from the preferred source through at least one of the identified channels.

10. The system of claim 9, wherein the user establishes a content source as a preferred source through a first channel related to the preferred source, and wherein the recommendation component identifies one or more channels related to the preferred source other than the first channel.

11. The system of claim 9, wherein the enablement component automatically enables the selected channels, and wherein the recommendation component provides the user the ability to selectively opt out of receiving content from the preferred source from any of the selected channels.

12. The system of claim 9, wherein the recommendation component provides the user the ability to selectively opt in to receiving content from the preferred source from any of the selected channels, and wherein the enablement component enables the user to access content from the preferred source through at least one of the identified channels where the user selective opted in.

13. The system of claim 9, wherein the recommendation component identifies the one or more channels according those channels with which the user interacts.

14. The system of claim 13 wherein the recommendation component further identifies the one or more channels according to user profile information.

15. The system of claim 9, wherein the enablement component enables user to access content from the preferred source through at least one of the identified channels by initiating the installation of a computer-executable module on a computing device associated with the user.

16. The system of claim 9, wherein the enablement component enables user to access content from the preferred source through at least one of the identified channels by subscribing to a content feed associated with the preferred source.

17. The system of claim 9, wherein the enablement component enables user to access content from the preferred source through at least one of the identified channels by adding contact information for the preferred source in a communication module on a computing device associated with the user.

18. A computer-readable medium bearing computer-executable instructions which, when executed on a computing system comprising at least a processor and a memory, carry out the following method comprising:
establishing a source of content as a preferred source for a computer user through a first channel;
identifying a plurality of channels other than the first channel through which content from the preferred source is available;
selecting from the identified plurality of channels those channels with which the user interacts; and
enabling the flow of content from the preferred source to the user through the selected channels.

19. The computer-readable medium of claim 18, wherein the flow of content from the preferred source to the user through the selected channels is automatically enabled, and wherein the user is provided with the ability to opt out of receiving content from the preferred source from any of the selected channels.

20. The computer-readable medium of claim 18, wherein the method further comprises presenting the selected channels to the user as recommended channels for the user with an option to opt in to receiving content from the preferred source from any of the selected channels, and enabling the flow of content from the preferred source to the user through those channels for which the user opts in.
